(19) United States
(12) Patent Application Publication
(10) Pub. No.: US 2015/0215755 A1
(43) Pub. Date: Jul. 30, 2015

(54) School-Wide Lockdown and Emergency Communication System

(71) Applicant: Joseph Bekanich, Exeter, PA (US)

(72) Inventor: Joseph Bekanich, Exeter, PA (US)

(21) Appl. No.: 13/999,220

(22) Filed: Jan. 30, 2014

(51) Int. Cl. H04W 4/22; H04W 76/00

(52) U.S. Cl. CPC H04W 4/22; H04W 76/007

(57) ABSTRACT

A multi-format emergency communication service for a school, office or home which allows for a non-law enforcement person to send a pre-defined location-based emergency digital message through a graphic user interface to a 911 emergency dispatcher or law enforcement individual and concurrently connect to the same 911 emergency dispatcher or law enforcement individual through a secure 2-way audio/video interface and messaging service. Additionally, a specially configured lockdown system/hardware will work in concert with the aforementioned emergency communication methods to lockdown and secure the door(s), window(s) or entry points at the said emergency location.

### BACKGROUND

The present application claims priority U.S. Provisional Patent Application No. 61/765,916 filed Feb. 18, 2013 and also claims priority to continuation in-part of U.S. patent application Ser. No. 13/717,707 filed Dec. 12, 2012 and also claims priority to continuation in-part of U.S. patent application Ser. No. 13/022,889 filed Sep. 7, 2012 and also claims priority to U.S. Provisional Patent Application U.S. No. 61/632,883 filed on Feb. 1, 2012 also claims priority to U.S. Provisional Patent Application U.S. No. 61/496,643 filed on Jun. 14, 2011 and also claims priority to U.S. patent application Ser. No. 13/022,889 filed Feb. 8, 2011 and also claims priority to U.S. Provisional Patent Application No. 61/339,863 filed on Mar. 10, 2010, and also claims priority to U.S. Provisional Patent Application No. 61/337,731 filed on Feb. 9, 2010, the contents of all of which is hereby incorporated herein by reference in their entireties.

Today's school, office and home environments are continually threatened by gun violence. In schools there has been little improvement in the means of keeping children and staff safe in the wake of an “active shooter” entering the building. Door locks and dead bolt locks offer little protection when fired at with commonly available guns such as hunting rifles of shot guns.

Methods to alerting and communicating with 911 communications center and law enforcement authorities about or during an active shooter are very limited. Many schools, classrooms and building, have “dead spots” where a cellular connection in unachievable due to their structure and design. Move over, hardwired phones and pay phones have been abandoned for the wide-spread adoption of wireless devices.

Many institutions have deployed cellular signal blocking or jamming devices to have “quite areas” where phones cannot ring or get a cellular signal. This limitation isolates people and their ability to freely communicate over traditional cellular means. Many schools and offices and companies utilize Wi-Fi internet connections. Typically Wi-Fi areas are limited to authorized personnel or employees and are usually password protected. For example, most schools only will allow teachers and administration to access Wi-Fi on a full time basis. Students will occasionally have temporary access to the Wi-Fi during class time or free time depending on the parameters set by the school or teacher.

The aforementioned limitations may create broken communication with 911 communications center and law enforcement authorities at critical times of an active shooting crisis. For law enforcement; time response, situational awareness and communication are critical to saving lives for students, teachers and staff as well as law enforcement. In the school, resilient lockdown hardware to secure classrooms and keep students safe as well has a school-wide communications to law enforcement and 911 authorities is paramount.

### SUMMARY

Applicants disclose systems and methods for 911/emergency communicating system and building-wide lockdown hardware for schools, offices buildings or structures. Using the systems and methods disclosed herein, users are able to have means of communication or message in to 911 communications center, law enforcement and or government authorities over existing FCC frequencies: VHF, UHF, 700/800/900 MHz. For example, during an emergency a user may use a specially designed digital remote-control, Fob or Graphic User Interface “GUI” on a wireless phone, PC tablet or computer to send a predefined location and emergency based one-way message from a classroom to law enforcement over a restricted law enforcement radio frequency. The message may contain predefined with a Ten-codes, Ten-signals, or Penal codes such as “10-67” and “10-72” as well as GPS information, location and contact information of the sender. The message from the GUI may be transmitted, created or deployed using one or a combination of, cellular, Internet, Wi-Fi, Micro-wave, VHF, SHF, UHF, 700/800/900 MHz frequencies and or communication methodologies. Concurrent to the aforementioned message being sent; a dedicated 2-way audio/video and advanced messaging service may be established directly between the sender and a 911 communication center and or law enforcement. Additionally, the aforementioned GUI may deploy pre-installed building-wide lockdown hardware to secure the doors, windows etc. at the sender's location.

In an illustrative embodiment, Applicant discloses specially designed Graphic User Interface “GUI” on a wireless phone, PC tablet or computer to send a predefined location and emergency based one-way message from a classroom to law enforcement over a restricted law enforcement radio frequency. The message is typically directed to at least one emergency and law enforcement personnel and may be directed to a plurality or group of emergency and law enforcement personnel. In an exemplary embodiment, the message may be repeated to ensure it was received by 911 communications center, law enforcement or government officials.

In the illustrative embodiment, the dedicated 2-way audio/video and advanced messaging service may be established directly between the sender and 911 communication center and or law enforcement over available communication methodologies. Alternatively, the system may include additional participants in the dedicated 2-way audio/video and advanced messaging service communication Additionally any and all 2-way or multi-way communication my contain embedded and real-time GPS-based time-stamping and recording.

In the illustrative embodiment, the building-wide lockdown hardware which is designed to secure the doors, windows etc. at the senders location may be a combination of special materials which are a combination of bullet-resistant and anti-ballistic materials. The system will be designed to be over built to withstand ballistic force. This system may be mounted on the inside of the door, (in the case that the door swings out) to prevent it from opening when the lockdown system is engaged. The system may be opened from within the room from which it engaged. Under certain emergency circumstances a specially designed key, flat or plunger may be used by emergency personnel to open the lockdown system from the outside of the door thru a specially designed clearance hole or keyway. This lockdown system is designed to be deployed through the aforementioned GUI, manually, automatically, remotely controlled, electronically, electro-magnetically by a solenoid, or other methodologies.

According to an aspect of the disclosed embodiments, users may schedule the delivery of messages for communication on a particular day and at a particular time. In a disclosed embodiment, the system monitors for the particular day and time specified for delivery, formats the message for delivery in the appropriate format, and communicates the message on the appropriate date and time.

The disclosed methods may be applied to particular markets or to a particular technical limitation which may work independently or as a complete solution. For example, a school, a home, church, office, building, government building, a warehouse, from a mode of transportation or a mode of travel.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

FIG. 1 is a block diagram of an illustrative computing arrangement in which aspects of the subject matter described herein may be implemented.

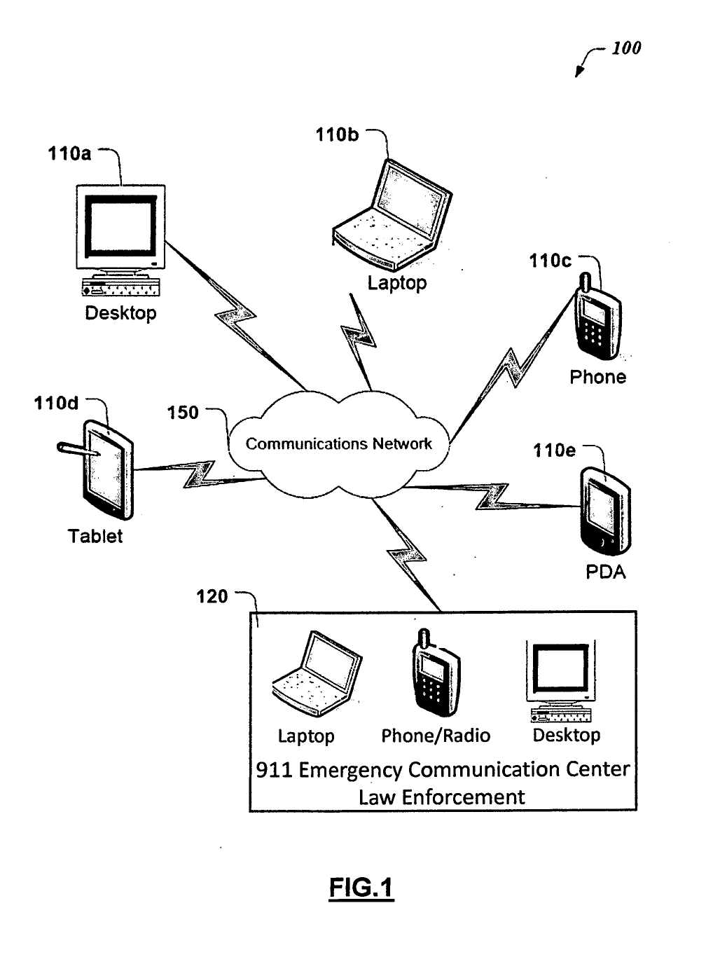

FIG. 2 is a flow diagram illustrating the process for communicating a predefined message to law enforcement.

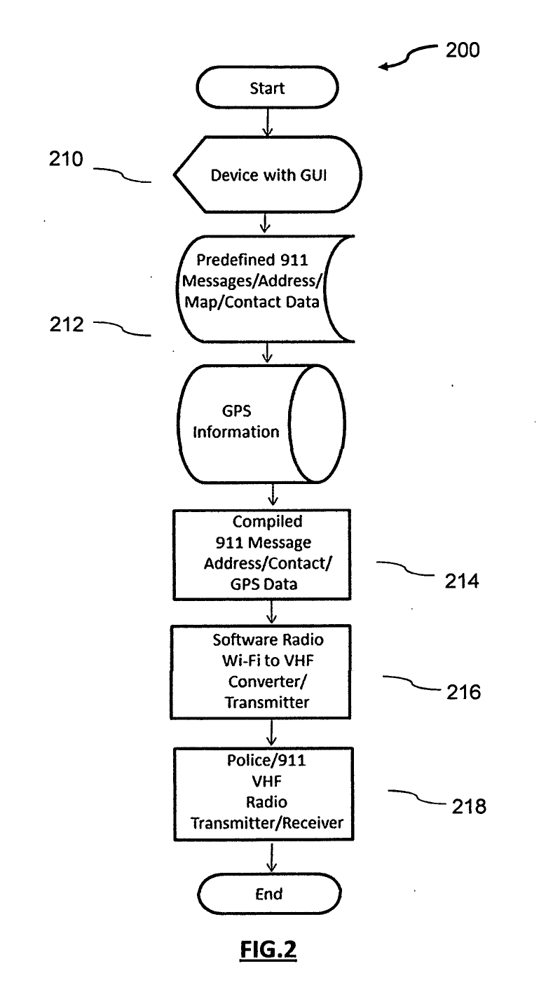

FIG. 3 is a flow diagram illustrating the process for communicating a predefined message and multi-way messaging with law enforcement.

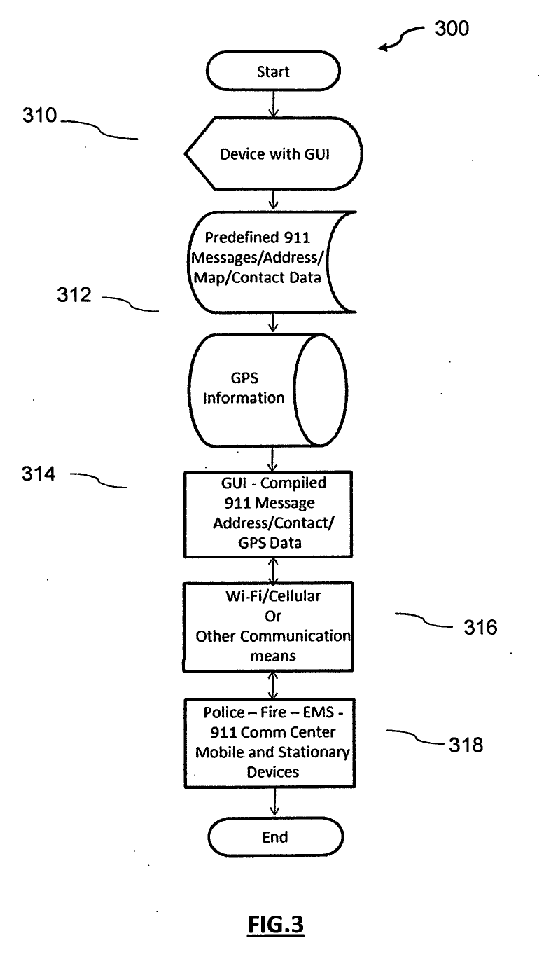

FIG. 4 is a flow diagram of an illustrating the process for contacting and communicating with law enforcement by secure audio/video 2-way communication.

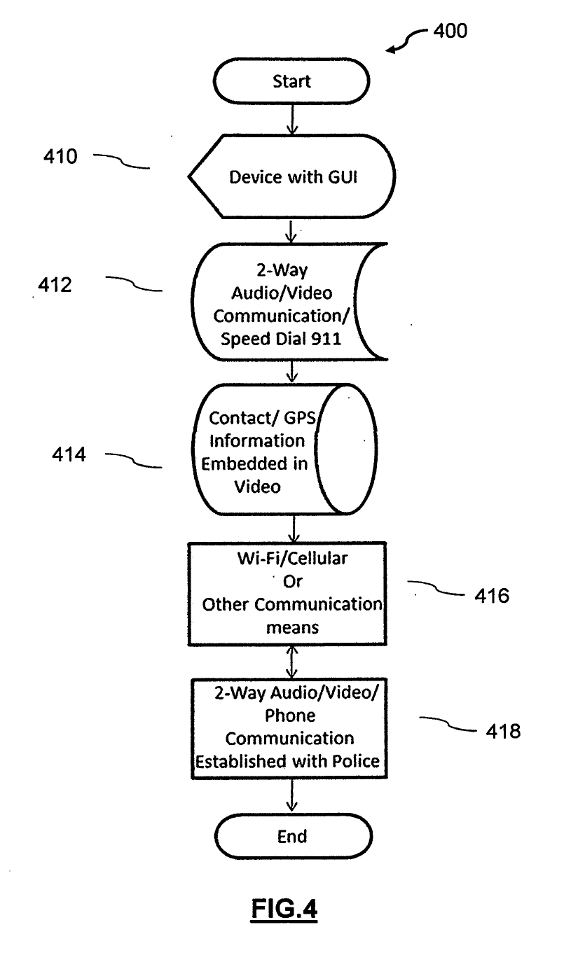

FIG. 5 depicts an illustrative user interface for entering a message and conducting 2-way audio/video communication with law enforcement.

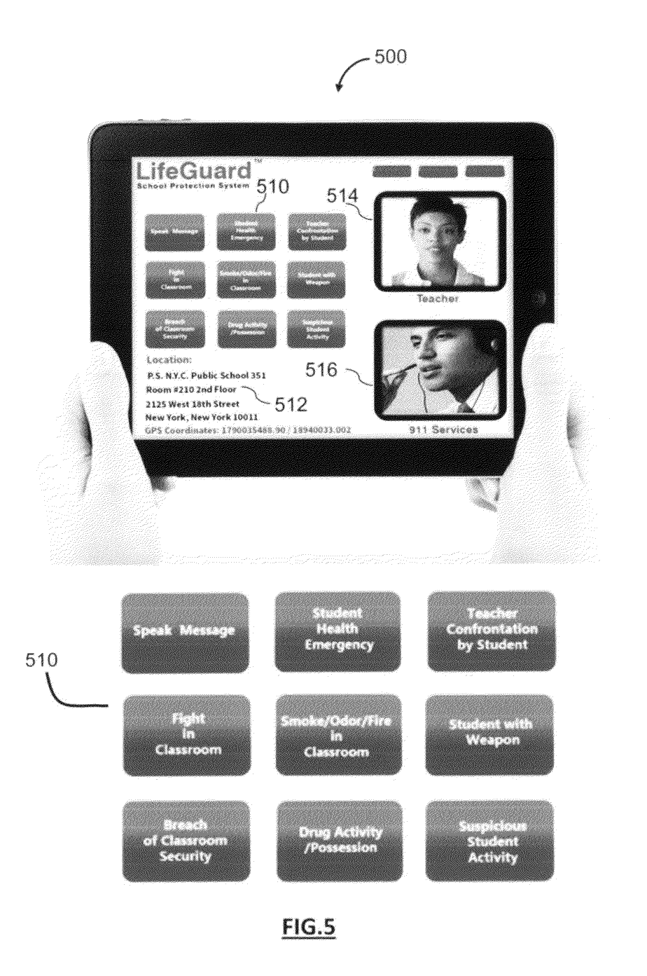

FIG. 6 depicts an illustrative user interface for communicating, locating and situational information before, during or after communication with law enforcement.

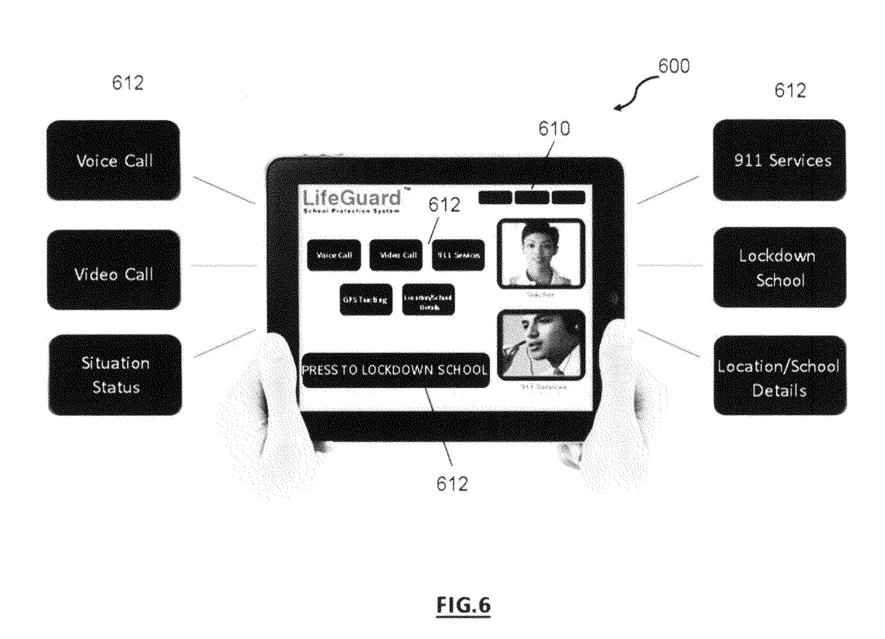

FIG. 7 depicts an illustrative for the door or window lockdown system.

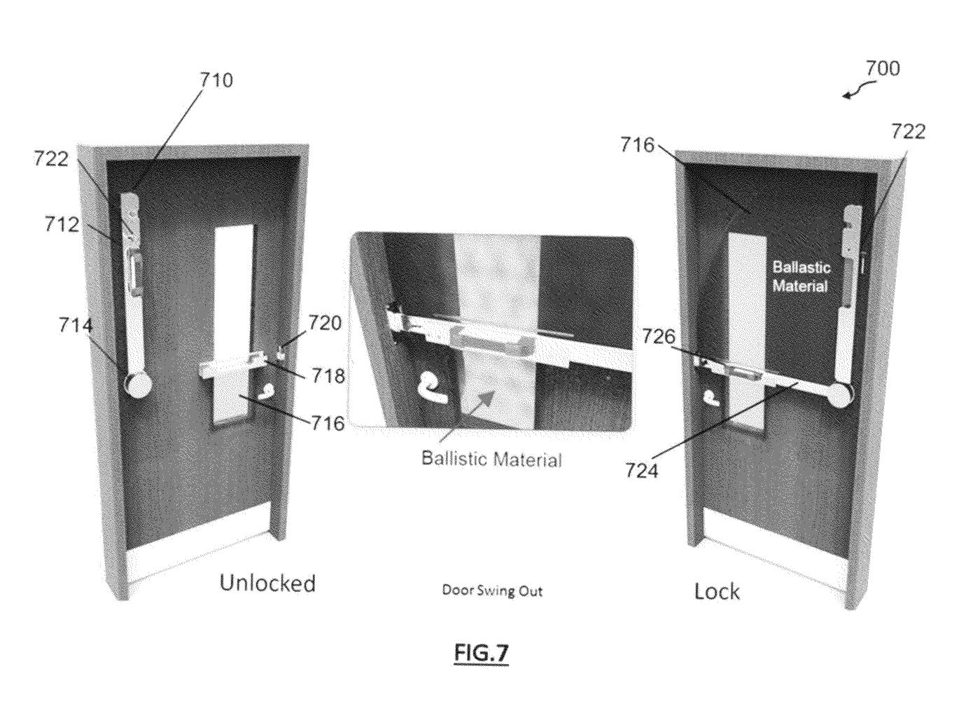

FIG. 8 depicts an illustrative view of the elements of the door or window lockdown system.

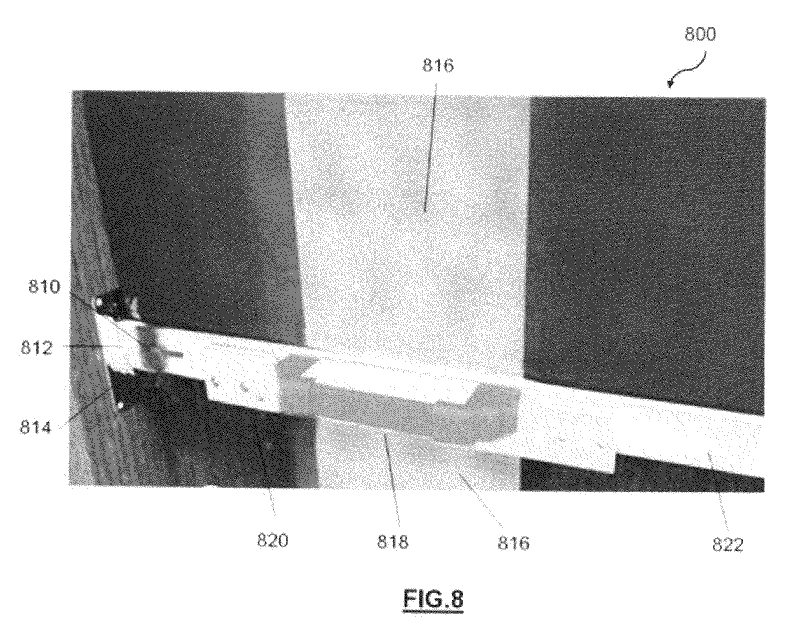

FIG. 9 depicts an illustrative view of an alternate of the door or window lockdown system.

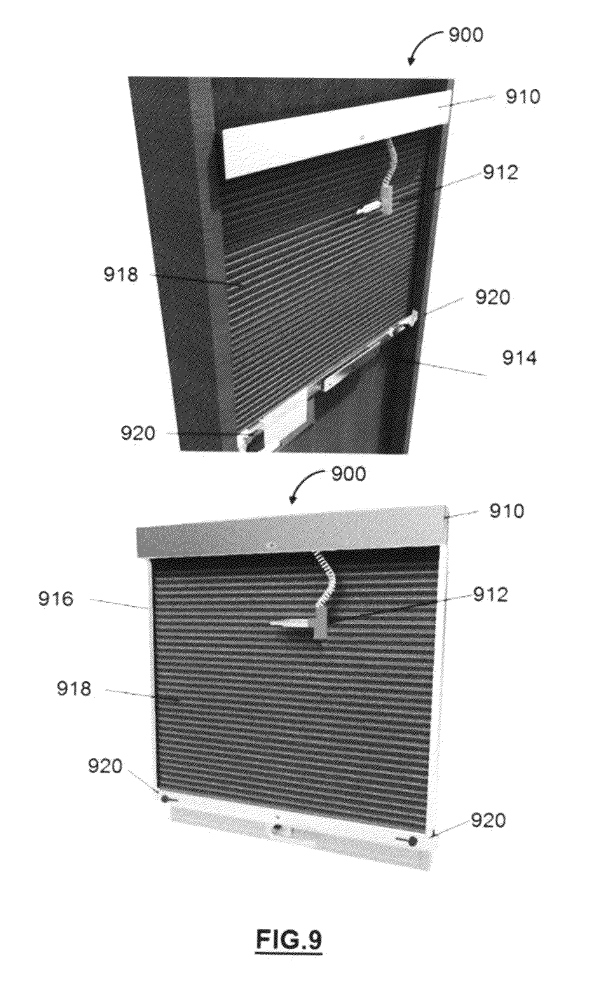

FIG. 10 is a illustrative diagram of a communication environment with which aspects of the subject matter described herein may be deployed.

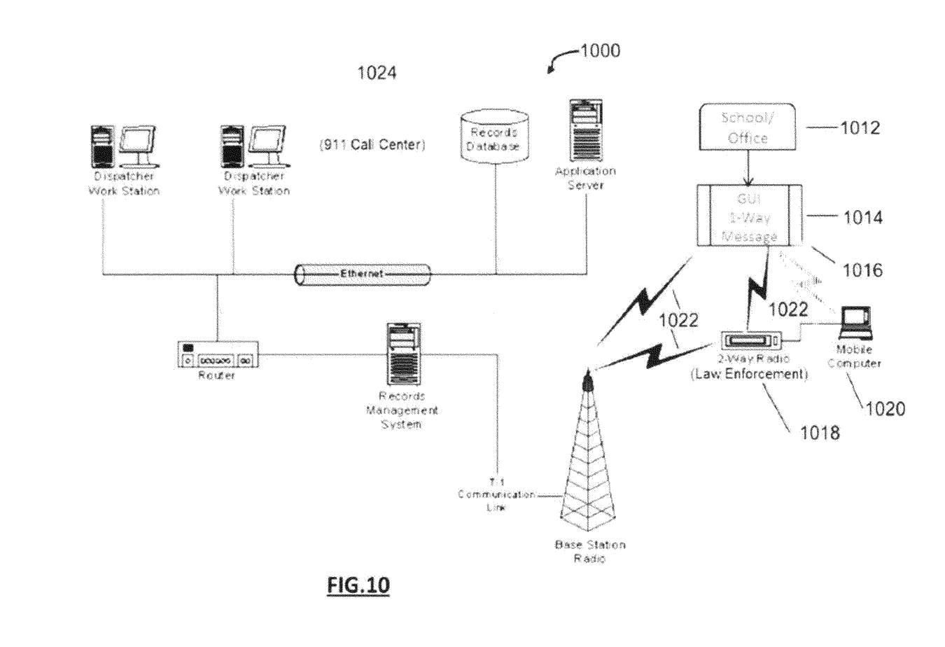

### DETAILED DESCRIPTION OF ILLUSTRATIVE EMBODIMENTS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for communicating digital information, comprising:
sending an emergency message in a digital format from a location, the message directed to at least one 911/emergency dispatcher or law enforcement individual;

2. The computer-implemented method of claim 1, wherein:
sending a message in a digital format comprises a web interface;
which maybe remain in its original format or be converted a second digital format for delivering the message to the at least one 911/emergency dispatcher or law enforcement individual over the law enforcement communications network.

3. The computer-implemented method of claim 1, wherein: sending a message in a digital format comprises a web interface; which maybe a one-way predefined emergency message which may remain in its original format or be converted a second digital format through software for delivering the message to the at least one 911/emergency dispatcher or law enforcement individual over the law enforcement communications network.

4. The computer-implemented method of claim 1, wherein: sending a message in a digital format comprises a web interface; which maybe a one-way predefined emergency message which may remain in its original format or be converted to a second digital format through software for delivering the message to the at least one 911/emergency dispatcher or law enforcement individual over the law enforcement communications network may contain stored contact and location information as well as real-time GPS information about the sender.

5. The computer-implemented method of claim 1, wherein: sending a message in a digital format comprises a web interface; which maybe a one-way predefined emergency message which may remain in its original format or be converted a second digital format for delivering the message to the at least one 911/emergency dispatcher or law enforcement individual over the law enforcement communications network which said emergency message maybe duplicated in different digital formats and distributed to at least one non-law enforcement individual over a non-law enforcement communications network.

6. The computer-implemented method of claim 1, wherein: sending a message in a comprises a web interface; digital format comprises a web interface; which maybe a one-way predefined emergency message which may be additionally initiated through remote control unit, a Fob, from a security system, through a breach of a sensor; or from synchronization with another system to a 911/emergency dispatcher or law enforcement individual over the law enforcement communications network.

7. The computer-implemented method of claim 1, wherein: sending a message in a comprises a web interface; digital format comprises a web interface; which maybe a one-way predefined emergency message which may be initiate a plurality of; alerts, systems, equipment, communications, onsite or remote services such as but not limited to: security systems, emergency services, rescue services and rescue drones.

8. A computer-implemented method for communicating digital information, comprising:
sending an emergency message in a digital format from a location, the message directed to at least one 911/emergency dispatcher or law enforcement individual;
which may initiate additional methods of communication concurrently to the sending the digital message to the at least one 911/emergency dispatcher or law enforcement individual defined in claim 1:

9. The computer-implemented method of claim 8, may open a secure means of communications directly through a 2-way Audio/Video interface between at least one 911/emergency dispatcher or law enforcement individual and the location of the sender.

10. The computer-implemented method of claim 8, may open a secure means of communications directly through a 2-way Audio/Video interface between at least one 911/emergency dispatcher or law enforcement individual and the location of the sender which may embed the senders contact information, address, location and GPS information in the 2-way Audio/Video interface.

11. The computer-implemented method of claim 8, may open a secure means of communications directly through a 2-way Audio/Video interface between at least one 911/emergency dispatcher or law enforcement individual and the location/sender which may use a 2-way messaging interface that copies and records all messages and or Audio/Video between the connected -2way Audio/Video 911/emergency dispatcher or law enforcement individual and the sender too a list of at least one law enforcement individual for situational awareness of the emergency.

12. A hardware-implemented lockdown system that comprises:
a door bar system which secures or lockdown one or more doors, windows or entry points from entry during an emergency or crisis.

13. The hardware-implemented lockdown method of claim 12, may be configured to mount on the door, window frame or encasement or entry point; off the door, window frame or encasement or entry point or a combination thereof and may work with or without the use of other locking or door hardware.

14. The hardware-implemented lockdown method of claim 12, may be configured to mount on the door, window frame or encasement or entry point; off the door, window frame or encasement or entry point or a combination thereof and may have hardware to allow for a pivot-point mount, spring-loaded locking and strike plate for securing or locking down a door, window entry point.

15. The hardware-implemented lockdown method of claim 12, may be configured to mount on the door, window frame or encasement or entry point; off the door, window frame or encasement or entry point or a combination thereof and may have a bullet-deflective shape or design and may use a built-in or attachable ballistic or bullet-proof material that cover the door, the door window(s), window and or window encasement or entry point.

16. The hardware-implemented lockdown method of claim 12, may contain a plurality of ballistic frames, plates, supports or structures to add anti-ballistic properties to be configured to mount on the door, window frame or encasement or entry point; off the door, window frame or encasement or entry point or a combination thereof and may work with or without the use of other locking or door hardware.

17. The hardware-implemented lockdown method of claim 12, may be deployed through the aforementioned GUI in claim 1, and or manually, automatically, remotely controlled, electronically, electro-magnetically by a solenoid, or other methodologies.

18. The hardware-implemented lockdown method of claim 12, may be locked or unlocked manually, automatically, remotely controlled, electronically, electro-magnetically by a solenoid, or other methodologies or in emergency circumstances a specially designed key, flat or plunger may be used by emergency personnel to open the lockdown system from the outside of the door, window or entrance way thru a specially designed clearance hole or keyway.
